(19) United States
(12) Patent Application Publication
(10) Pub. No.: US 2016/0230691 A1
(43) Pub. Date: Aug. 11, 2016

(54) METHOD FOR OPERATING A FUEL INJECTOR

(71) Applicant: Robert Bosch GmbH, Stuttgart (DE)

(72) Inventors: Matthias Boee, Ludwigsburg (DE); Andreas Schaad, Maulbronn (DE); Michael Bauer, Gerlingen (DE)

(21) Appl. No.: 15/014,660

(22) Filed: Feb. 3, 2016

(30) Foreign Application Priority Data
Feb. 11, 2015 (DE) 102015202389.3

(51) Int. Cl. F02D 41/30; F02M 51/06; F02D 41/26; F02M 61/18

(52) U.S. Cl. CPC F02D 41/3005; F02M 61/18; F02M 51/06; F02D 41/26

(57) ABSTRACT

A method for operating a fuel injector, in particular of an internal combustion engine, is described. At least one first injection and one second injection take place in succession. A valve needle reaches its closed position at a first point in time. The triggering of the second injection begins at the first point in time.

### CROSS REFERENCE

The present application claims the benefit under 35 U.S.C. §119 of German Patent Application No. 102015202389.3 filed on Feb. 11, 2015, which is expressly incorporated herein by reference in its entirety.

### BACKGROUND INFORMATION

The present invention is directed to a method for operating a fuel injector. The subject matter of the present invention is also a computer program, a machine-readable memory medium, a control unit, and a program code.

A method for operating a fuel injector is described in German Patent Application No. DE 10 2009 002 483 A1. In this method, a valve needle is driven with the aid of an electromagnetic actuator. A variable characterizing the acceleration of a magnet armature of the electromagnetic actuator is formed as a function of at least one electrical operating parameter. Based on this variable characterizing the acceleration, the operating state of the fuel injector is inferred.

In the fuel injector described there, the magnet armature is not fixedly connected to the valve needle, but instead is in an overhung position between two stops.

The axial play between the magnet armature and the two stops is referred to as the armature free travel. A compression spring ensures that the magnet armature is always in contact with the combustion-chamber-side stop in the idle state and thus the complete armature free travel is available as an acceleration distance when the injector is activated.

It is advantageous in a system of this type that, due to the impulse of the armature generated during opening at the same magnetic force, the valve needle may also be safely opened even at higher fuel pressures. Due to the decoupling of the masses between the valve needle and the armature, the impact force in the seat is divided into two impulses.

It is disadvantageous in this system that the armature rebounds after striking the lower stop during closing of the injector. It may thereby occur that the complete armature free travel is run through again and the armature still has so much energy upon renewed impact on the upper stop that the valve needle is lifted out of the seat once again for a short time. This results in undesirable post-injections, increased pollutant emissions and increased consumption by the vehicle. Even if the armature does not run through the complete armature free travel during the rebound, it still requires some time until it is settled again.

If the armature is activated again before the final settling, a less robust function of the fuel injector results. This is disadvantageous, in particular in the case of multiple injections with short pauses between the individual injections. The case may thereby occur that the impact impulses are correspondingly increased or decreased.

### SUMMARY

An example method according to the present may have the advantage over the related art that two injections may be triggered quickly one after the other. In the process, very short pause times may be implemented. Additional sensors are not necessary for the method according to the present invention, since variables from other functionalities may be used.

These advantages are thus achieved in that the triggering of a second injection begins at a first point in time. At this first point in time, a valve needle reaches its closed position during a first injection. This means that as soon as the valve needle reaches its closed position during the first injection, the triggering of the second injection begins. If the interval between the end of the triggering and the point in time of the closing of the valve needle is referred to as the closing time, and the interval between the end of the triggering for the first injection and the beginning of the second injection is referred to as the pause time, then the closing time and the pause time are practically of the same length.

It may be advantageous if two injections may follow each other at a very short interval. The first injection hereby positively influences the second injection. Thus, since the second injection coincides with the closing point in time of the first injection, a defined state of the system virtually arises and the second triggering provides a reproducible injection.

It may be advantageous if the triggering of the second injection begins after the first point in time and before the second point in time at which a magnet armature reaches its end position. In this specific embodiment, the demands for accuracy are lower. The advantages are, however, achieved to the greatest possible extent.

The most advantageous triggering results if the triggering of the second injection begins directly after the first point in time at which the valve needle closes.

It may be further advantageous if the first point in time is ascertained based on an operating parameter of the fuel injector.

It may be advantageous if the current which flows through the fuel injector, and/or the voltage which is applied at the fuel injector is evaluated as the operating parameter. These variables are either easy to ascertain or are already available in the control unit for other tasks.

If the first point in time is read out from an engine characteristic map based on parameters of the internal combustion engine, the ascertainment of the point in time may be dispensed with. In addition, the method is also usable in operating states in which the first point in time is not ascertainable or is only ascertainable with difficulty.

It may be particularly advantageous hereby if the first point in time is ascertained in the presence of certain parameters of the internal combustion engines based on operating parameters of the fuel injector and is entered into the engine characteristic map. Thus, the engine characteristic map may be adapted during ongoing operation to aging effects or other changes.

In an additional aspect, the present invention relates to program code together with processing instructions for compiling a computer program executable on a control unit, in particular, source code with compiler and/or linking instructions, the program code resulting in the computer program for carrying out all steps of a described method, if it is converted into an executable computer program according to the processing instructions, i.e., in particular, compiled and/or linked. This program code may be provided in particular by source codes which, for example, are downloadable from a server on the internet.

### BRIEF DESCRIPTION OF THE DRAWINGS

Exemplary embodiments of the present invention are represented in the figures and are explained in greater detail below.

FIG. 1 shows a schematic representation of an internal combustion engine including multiple fuel injectors operated according to an example embodiment of the present invention,

FIGS. 2a through 2c show a schematic representation of one fuel injector from FIG. 1 in three different operating states.

FIG. 3 shows different signals plotted over the time.

### DETAILED DESCRIPTION OF EXAMPLE EMBODIMENTS

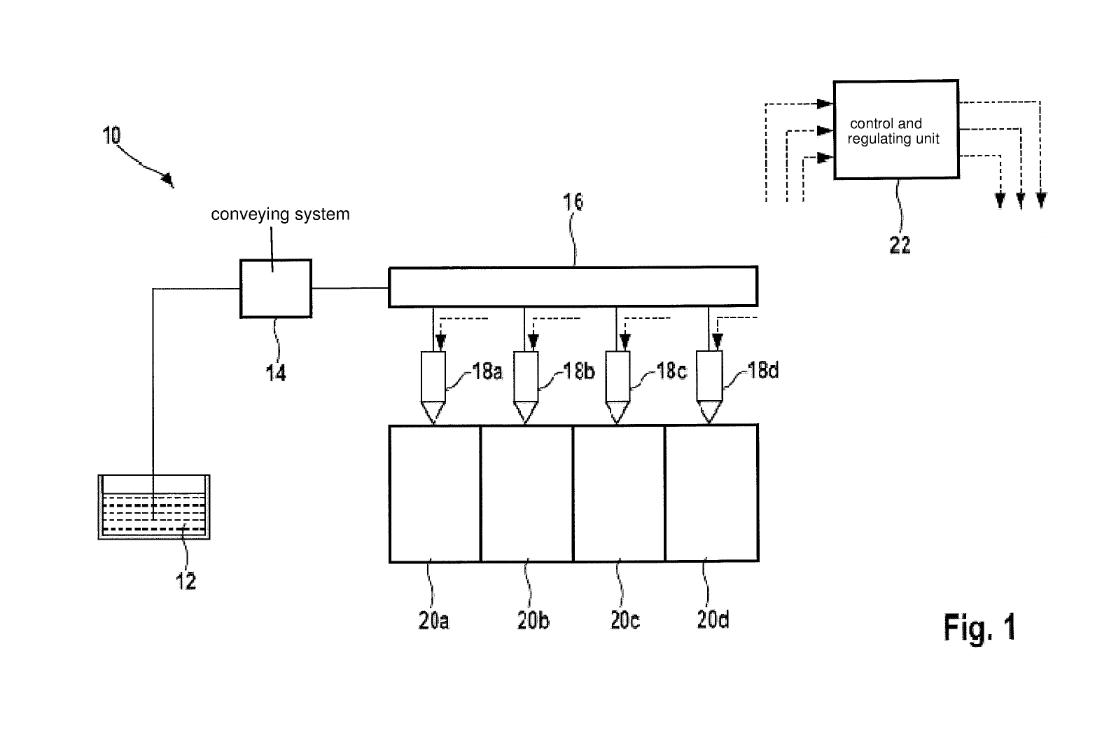

An internal combustion engine bears as a whole the reference numeral 10 in FIG. 1. It includes a tank 12, from which a conveying system 14 conveys fuel into a common rail 16. Multiple electromagnetically actuated fuel injectors 18a through 18d are connected to the common rail which inject the fuel directly into their assigned combustion chambers 20a through 20d. The operation of internal combustion engine 10 is controlled or regulated by a control and regulating unit 22, which also activates fuel injectors 18a through 18d, among other things.

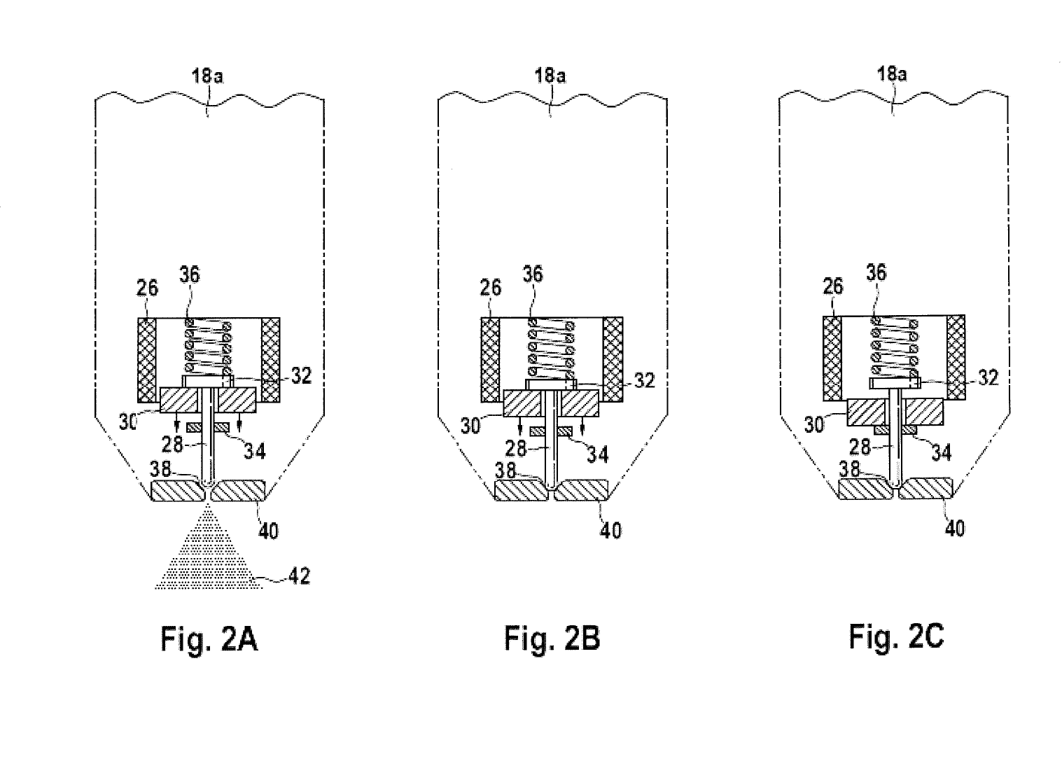

FIGS. 2a through 2c schematically show fuel injector 18a according to FIG. 1 in a total of three different operating states. Additional fuel injectors 18b, 18c, 18d shown in FIG. 1 have a corresponding structure and functionality.

Fuel injector 18a includes an electromagnetic actuator which has a solenoid coil 26 and a magnet armature 30 interacting with solenoid coil 26. Magnet armature 30 is connected to a valve needle 28 of fuel injector 18a in such a way that, with respect to a vertical moving direction of valve needle 28 in FIG. 2a, it is movable with a non-negligible mechanical play relative to valve needle 28.

Thus, a two-part mass system 28, 30 arises which effectuates the drive of valve needle 28 by electromagnetic actuator 26, 30. This two-part configuration improves the installability of fuel injector 18a and an undesirable rebound of valve needle 28 during impact on its valve seat 38 is reduced.

In the present configuration illustrated in FIG. 2a, the axial play of magnet armature 30 on valve needle 28 is limited by two stops 32 and 34. However, at least lower stop 34 in FIG. 2a might also be implemented by an area of the housing of fuel injector 18a.

Valve needle 28 is acted upon by a valve spring 36, as is shown in FIG. 2a, by an appropriate spring force against valve seat 38 in the area of housing 40. In FIG. 2a, fuel injector 18a is shown in its open state. In this open state, magnet armature 30 is moved upward due to energization of solenoid coil 26 in FIG. 2a so that, upon engaging in stop 32, valve needle 28 is moved out of its valve seat 38 against the spring force. Thus, fuel 42 may be injected by fuel injector 18a into combustion chamber 20a (FIG. 1).

As soon as the energization of solenoid coil 26 is ended by control unit 22 (FIG. 1), valve needle 28 moves, due to the effect of the spring force exerted by valve spring 36, toward its valve seat 38 and entrains magnet armature 30. A power transmission from valve needle 28 to magnet armature 30 takes place here in turn by upper stop 32.

As soon as valve needle 28 completes its closing movement with the impact on valve seat 38, magnet armature 30, as shown in FIG. 2b, may move further downward, due to the axial play in FIG. 2b, until it contacts second stop 34, as is illustrated in FIG. 2c.

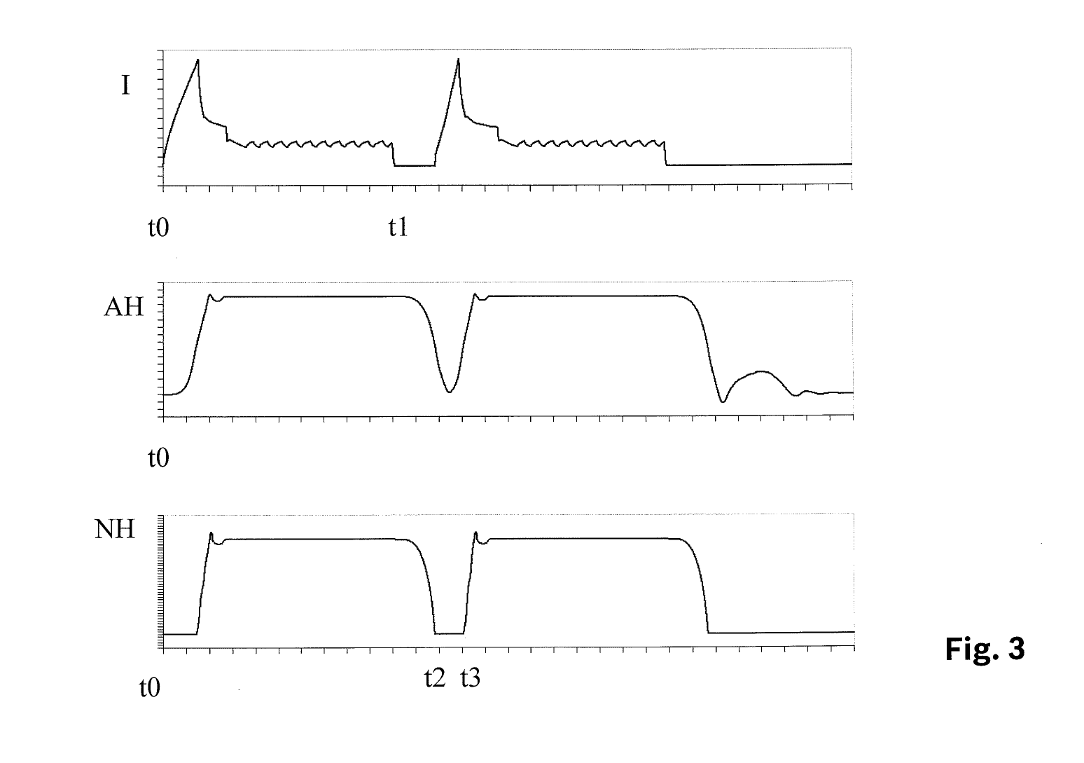

In FIG. 3, different variables are plotted over the time; two injections are depicted here. In the first line, current I flowing through solenoid coil 26 is shown. In the second line, lift AH of magnet armature 30 is plotted, and in the third line, lift NH of valve needle 28 is plotted over the time. This representation of the progressions is selected only by way of example.

The energization of solenoid coil 26 begins at point in time t0. After a short delay, magnet armature 30 begins to move and entrains valve needle 28. Both reach their maximum lift after a short time.

At point in time t1, the energization is discontinued and the magnet armature begins to fall back. Valve needle 28 is simultaneously moved into its closed position by the spring. The valve needle reaches its closed position at point in time t2. Due to its inertia, the magnet armature has not yet reached its stop at point in time t2.

It is provided according to the example embodiment of the present invention, that the energization of the next injection begins at point in time t2, at which valve needle 28 reaches its closed position. This results in that the armature moves again in its other direction and the valve needle changes over again into its open position.

It is provided in one particularly simple specific embodiment, that point in time t2, at which the valve needle reaches its closed state, is measured for each injection. The progression of current I flowing through the solenoid coil or the voltage applied at the solenoid coil is preferably evaluated to ascertain point in time t2. Numerous conventional methods are available for this purpose. A corresponding method is described in the related art.

In one additional specific embodiment, it may also be provided that point in time t1 or the period between the end of the energization at point in time t1 and point in time t2 is stored in a memory in the control unit. This value is preferably stored in an engine characteristic map as a function of the operating state of the internal combustion engine and/or of the driven vehicle. This is advantageous since it is not possible to ascertain point in time t2 in all operating states with sufficient accuracy, or the ascertainment requires computing time.

It may be advantageous in this specific embodiment if the period is stored and the triggering of the second injection begins by this period after the end of the triggering of the first injection.

It may also be provided in one embodiment that point in time t2 or the period is ascertained in specific operating states of the internal combustion engine and is stored in a memory or an engine characteristic map for later use.

The triggering of the second injection should take place so soon after the end of the triggering of the first injection that the valve needle has reached its closed position; however, the magnet armature is still in motion. It is also possible here that the triggering of the second injection already begins when the valve needle has not yet completely reached its closed position.

What is claimed is:

1. A method for operating a fuel injector of an internal combustion engine comprising:
performing at least one first injection and one second injection in succession, a valve needle reaching its closed position at a first point in time;
wherein the second injection is triggered at the first point in time or directly after the first point in time.

2. The method as recited in claim 1, wherein the triggering of the second injection begins after the first point in time and before a second point in time at which a magnet armature reaches its end position.

3. The method as recited in claim 1, wherein the first point in time is ascertained based on an operating parameter of the fuel injector.

4. The method as recited in claim 3, wherein at least one of: i) a current which flows through the fuel injector, and ii) a voltage which is applied at the fuel injector, is evaluated as the operating parameter.

5. The method as recited in claim 1, wherein the first point in time is read out from an engine characteristic map based on parameters of the internal combustion engine.

6. The method as recited in claim 5, wherein the first point in time is ascertained in the presence of certain parameters of the internal combustion engine based on operating parameters of the fuel injector and is entered into the engine characteristic map.

7. A machine-readable memory medium on which an executable computer program is stored, the computer program, when executed by a processor, causing the processor to perform:
at least one first injection and one second injection in succession, a valve needle reaching its closed position at a first point in time;
wherein the second injection is triggered at the first point in time or directly after the first point in time.

8. A control unit which is configured to cause:
at least one first injection and one second injection in succession, a valve needle reaches its closed position at a first point in time;
wherein the second injection is triggered at the first point in time or directly after the first point in time.
